(19) United States
(12) Patent Application Publication
(10) Pub. No.: US 2024/0057506 A1
(43) Pub. Date: Feb. 22, 2024

(54) Methods And Systems For Use In Harvesting Crops

(71) Applicant: MONSANTO TECHNOLOGY LLC, Saint Louis, MO (US)

(72) Inventors: Daniel Michael DUCKWORTH, Saint Louis, MO (US); Ganesh KUMAR, Chesterfield, MO (US); Raymond Scott LINDSEY, Constantine, MI (US); Alexander Harry SHERIDAN, Saint Charles, MO (US); Sreelatha SUNKUGARI, Ellisville, MO (US); Ni WAN, Saint Louis, MO (US)

(21) Appl. No.: 18/235,761

(22) Filed: Aug. 18, 2023

Related U.S. Application Data
(60) Provisional application No. 63/399,558, filed on Aug. 19, 2022.

(51) Int. Cl. A01B 79/00; G06Q 10/0639; G06Q 50/02

(52) U.S. Cl. CPC A01B 79/005; G06Q 10/06395; G06Q 50/02

(57) ABSTRACT

Systems and methods for providing agricultural operation(s) for a crop, in manner consistent with a predicted quality of the crop are described. One example computer-implemented method includes accessing, by a computing device, data associated with a crop in a target field, where the data includes planting data for the crop and weather data for the target field, and correlating the weather data to each of a plurality of growth stages for the crop in the target field. The method then includes, prior to a harvest of the crop from the target field, determining, by the computing device, a quality of the crop in the target field, based on the correlated weather data and a quality model specific to a type of the crop, and directing at least one agricultural operation consistent with the determined quality of the crop in the target field.

### CROSS-REFERENCE TO RELATED APPLICATION

This application claims the benefit of, and priority to, U.S. Provisional Application No. 63/399,558, filed on Aug. 19, 2022. The entire disclosure of the above application is incorporated herein by reference.

### FIELD

The present disclosure generally relates to methods and systems for use in harvesting crops (and/or otherwise managing the crops), and in particular, to methods and systems for providing planting and/or harvesting operation(s) for crops in fields (and/or other management operations for the crops in the fields such as treatments, etc.), in manners consistent with a determined quality of the crops in the fields (e.g., a calculated quality of the corps, a predicted quality of the corps, etc.).

### BACKGROUND

This section provides background information related to the present disclosure which is not necessarily prior art.

Crops are planted, grown, and harvested in various regions. After growers plant the crops, depending on types of the crops, the crops progress to harvesting. The growth of the crops is known to be impacted, for example, by the weather in the regions of the crops or other factors. In connection with harvesting the crops, then, the growers will make decisions about timing of the harvest, and potentially, other decisions related to the manner, bagging or tagging (or labeling) of the harvested crops, based on the weather or other factors. In addition, in connection with harvesting and further processing the crops, the tagging, for example, may indicate a particular quality of the harvested crops included in the associated bags. Further, once the harvested crops are bagged, it is known for the growers to ship the harvest crops to one or more consumers, which may then use the harvested crops in various ways (e.g., as seed, as feed, etc.).

### SUMMARY

This section provides a general summary of the disclosure and is not a comprehensive disclosure of its full scope or all of its features.

Example embodiments of the present disclosure generally relate to methods for providing (e.g., prioritizing, etc.) agricultural operations (e.g., planting operations, harvest operations, etc.) for a crop, in manner consistent with a predicted quality of the crop. In one example embodiment, such a method generally includes accessing, by a computing device, data associated with a crop in a target field, the data including planting data for the crop and weather data for the target field; correlating, by the computing device, the weather data to each of a plurality of growth stages for the crop in the target field; prior to a harvest of the crop from the target field, determining, by the computing device, a quality of the crop in the target field, based on the correlated weather data and a quality model specific to a type of the crop and independent of a physical examination of the crop in the target field; and directing at least one agricultural operation consistent with the determined quality of the crop in the target field.

Example embodiments of the present disclosure also generally relate to systems for providing (e.g., prioritizing, etc.) agricultural operations (e.g., planting operations, harvest operations, etc.) for a crop, in manner consistent with a predicted quality of the crop. In one example embodiment, such a system generally includes a computing device configured to access data associated with a crop in a target field, the data including planting data for the crop and weather data for the target field; correlate the weather data to each of a plurality of growth stages for the crop in the target field; prior to a harvest of the crop from the target field, determine a quality of the crop in the target field, based on the correlated weather data and a quality model specific to a type of the crop and independent of a physical examination of the crop in the target field; and direct at least one agricultural operation consistent with the determined quality of the crop in the target field.

Example embodiments of the present disclosure also generally relate to non-transitory computer-readable storage media including executable instructions for providing (e.g., prioritizing, etc.) agricultural operations (e.g., planting operations, harvest operations, etc.) for a crop, in manner consistent with a predicted quality of the crop. In one example embodiment, a non-transitory computer-readable storage medium includes executable instructions, which when executed by at least one processor, cause the at least one processor to perform one or more of the steps recited in any of the methods herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for providing planting operations, harvest operations, etc. for a crop in a field, in a manner consistent with a predicted, estimated, calculated, etc. quality of the crop;

FIG. 2 is a block diagram of an example computing device that may be used in the system of FIG. 1;

FIG. 3 illustrates a flow diagram of an example method, which may be used in (or implemented in) the system of FIG. 1, for use in harvesting a crop in a field, in a manner consistent with a predicted, estimated, calculated, etc. quality of the crop; and

FIG. 4 illustrates an example growth stage progression for a soybean crop that may be harvested in accordance with the present disclosure, from a planting date to a harvest date.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

As part of the harvesting of crops in fields (e.g., the harvesting of multiple plants included in the crops, etc.), certain decisions may be made depending on quality of the crops in the fields. For example, a specific tag (or label, etc.), or a specific bag, may be used for a harvested crop based on an assumed or tested quality of the crop. More particularly, a particular tag for a given quality of a crop may be associated with the crop at harvest, whereby the tag (e.g., the tag itself, the application of the tag to the crop, etc.) then is part of the harvest process (and, more generally, processing) of the crop. However, it is often problematic to test the crop, while the crop is still in the field or even after the crop is harvested, due to timing and rate constraints associated with harvesting the crop and subsequently processing the harvested crop. Further, when the assumed quality of a crop is incorrect, the bags of the harvested crop may have to be re-tagged (or re-labeled), or even re-bagged, which provides inefficiencies and additional associated costs to the harvesting process. Beyond these inefficiencies and additional costs, assumptions (e.g., incorrect assumptions, unsupported assumptions, etc.) about the quality of a crop in a field may drive incorrect decisions about harvest times, while physical testing of the crops in the field, to determine actual quality, is often unworkable and/or cumbersome for growers of certain sizes, etc.

Uniquely, the systems and methods herein provide for a prediction, estimation, calculation, etc. of a quality of a crop in a given target field, based on data associated with the both the crop and the field, such as, for example planting date of the crop in the field, weather data for a location/region including the field, etc.

In particular, prior to harvest of a crop (or multiple crops) in a field, a quality computing device accesses different data related to the crop(s) and to the field, and predicts the growth stage(s) of the crop(s) of the field, and then correlates the accessed data to the growth stage(s). The quality computing device next employs a model to predict the quality of the crop(s), based on the accessed data and correlation, as organized, for example, by growth stage. In this manner, a grower may be informed of a predicted quality of the crop(s) (or associated seed) in the field (e.g., as advanced notice not previously available without costly and inefficient physical testing, etc.), whereby a harvest time, or specific tag or bag for use in subsequent processing of the crop(s), may be designated for the field, in advance of the actual harvest, etc. (and instead of with (or at the same time as) the harvest or instead of waiting to do so after harvest, as is conventional). As such, through the systems and methods herein, the predicted quality of the crop(s) in the field provides for more accurate harvesting and/or improved efficiencies in the harvesting of the crop(s). What's more, because the predicted quality, as described herein, may be determined independent of physical measurements of the crop(s) in the field, the systems and method herein may provide further efficiencies, for example, in limiting manual interaction with the crop(s) and/or eliminating bulk testing in connection with harvesting the crop(s), etc.

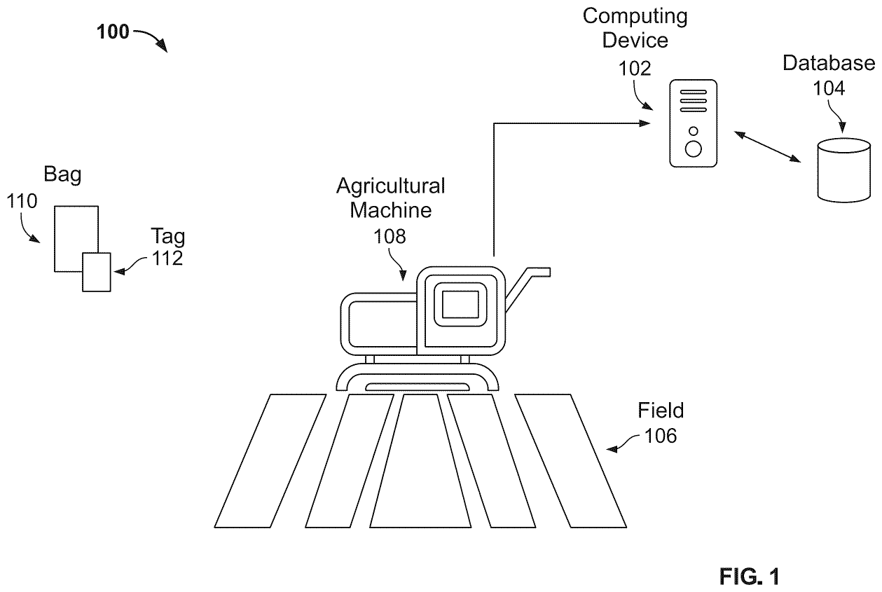

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, models implemented for growth stage determinations, types of crops in the field, number of fields, geographic locations of the fields, etc.

In the example embodiment of FIG. 1, the system 100 generally includes a specially (or specifically) configured quality computing device 102 and a database 104. The database 104 is coupled to (and/or is otherwise in communication with) the computing device 102, as indicated by the arrowed line. The quality computing device 102 is illustrated as separate from the database 104 in the embodiment of FIG. 1, yet in communication with the database 104, as indicated by the arrowed line. The database 104 then, for example, may include a cloud-based database, or other database for storing data, which is accessible to the computing device 102. It should be appreciated, though, that in other system embodiments the database 104 may be included, in whole or in part, in the computing device 102.

The system 100 also includes an example field 106. While only one field 106 is illustrated in FIG. 1, it should be appreciated that in various embodiments the system 100 will generally include dozens, hundreds, or thousands of fields, of which field 106 is representative, depending, for example, on associations of various growers, size of growers, etc. The field 106, in general, is provided for planting, growing, and harvesting a crop or multiple crops, etc. In the illustrated embodiment, the field 106 includes at least one crop planted therein (e.g., at least one plant associated with the at least one crop, etc.). In connection therewith, then, the crop (and/or plant associated therewith) may include, for example (and without limitation), one or more row or other suitable crop, etc. In some example embodiments, the crop may include, for example (and without limitation), corn (or maize), wheat, beans (e.g., soybeans, etc.), peppers, tomatoes, tobacco, eggplant, rice, rye, sorghum, sunflower, potatoes, cotton, sweet potato, sugar beets, sugarcane, oats, barley, vegetables, or other suitable crop or products or combinations thereof, etc. In addition, plots of the field 106 may each include the same type of plants/crop, or a number of different varieties of the same type of plants (or crop), or different types and/or combinations of plants/crops (e.g., planted in rows, etc.).

The crop included in the field 106 in this example embodiment is soybeans. In connection therewith, example growth stages for soybeans are presented below in Table 1.

TABLE 1

| Growth Stage | Description |
|---|---|
| P | Planting |
| VE | Emergence |
| VC | Unifoliate leaves unrolled |
| V1-V8 | 1^{st} . . . 8^{th} trifoliate leaf unfolded |
| R1 | Beginning flowering |
| R2 | Full bloom |
| R3 | Beginning pod |
| R4 | Full pod |
| R5 | Beginning seed |
| R6 | Full seed |
| R7 | Beginning maturity |
| R8 | Full maturity |
| H | Harvesting |

In addition, the system 100 includes an agricultural machine 108. In some embodiments the agricultural machine 108 may include, for example, a harvesting implement (e.g., a combine, a harvester, a picker, a bagger, etc.), which is configured to harvest the crop from the field 106 and other fields, and potentially, bag the harvested crop from the field 106 (broadly, process the crop). Additionally, in some embodiments, the agricultural machine 108 may include a planting machine, which is configured to plant the crop in the field 106, or a treatment machine, which is configured to apply one or more treatments to the field 106 (and/or the crop in the field 106), or an irrigation machine, which is configured to apply irrigation to the field 106 (and/or crop in the field 106). In general, the agricultural machine 108 may include any machine associated with one or more operations related to the field 106 and/or the crop in the field 106, which may be configured to interact with the field 106, etc. The agricultural machine 108 may further be configured to receive executable instructions from the computing device 102 and execute the instructions at the field 106, to thereby control, alter, etc. one or more operation of the agricultural machine 108 to affect the crop in the field 106.

That said, while one agricultural machine 108 is illustrated in FIG. 1, it should be appreciated that the system 100 may include multiple such machines in other example embodiments associated with the field 106 and/or with other fields (e.g., multiple of the same type of agricultural machine, multiple different types of agricultural machines, etc.).

In connection with harvesting of the crop in the field 106, the agricultural machine 108 is associated with bag 110 and tag 112. More generally, the agricultural machine 108 is associated with multiple bags, each of which is associated with a tag. In general, the bag 110 (and other bags) is/are configured to contain and/or hold the crop (or a portion thereof), once the crop is harvested, for delivery to one or more locations. The tag 112, on the other hand, includes an indication of the type of crop, in this example, and also an indication of a quality of the crop (or seed) included in the corresponding bag 110. The tag 112 may also include other data, including, without limitation, a harvest date for the crop included in the bag 110, a weight, grower information (e.g., name, address, identifier, etc.), a field identifier for the field 106, etc. It should be appreciated that the tag 112 may be associated with the bag 110, by affixing it thereto (e.g., via a tie, a band, a rivet, a pin, etc.), etc. (e.g., where the tag 112 may include a label, etc.). Alternatively, or additionally, it should further be appreciated that in one or more system embodiments, the tag 112 may be integrated with the bag 110, whereby the bag 110 and the tag 112 are assembled and/or made together (e.g., where the tag 112 may be printed on the bag 110, where the tag 112 may include a machine readable indicia (e.g., a QR code, etc.) incorporated onto or into the bag 110, where the tag 112 may include a RFID tag incorporated onto or into the bag 110, etc.). The data included on (or associated with) the tag 112 may be included in the database 104.

In this example embodiment, the computing device 102 is configured to then access the data (and other date as described herein) included in the database 104, as desired (e.g., upon instruction or request from a user, at a particular or desired interval, at other times, etc.) and to compute a quality of the crop in the field 106.

At the outset, the database 104 includes various data, such as, for example, planting data for the crop in the field 106 (and potentially for other crops planted in the field 106 and for other crops in other fields, etc.), weather data for the a location, region, etc. including the field 106 (and, potentially, for other locations, regions, etc.), etc., and also one or more models for use by the computing device 102 as described herein (e.g., growth stage models, quality models (or quality prediction models), etc.). The planting data may include, without limitation, identifying data for the field 106, a crop type in the field 106, a planting date for the crop, planting characteristics for the crop (e.g., spacing, etc.), and a relative maturity (RM) of the crop, etc. The planting data may further include image data for the field 106 (and, additionally, for the crops in the field 106). It should be appreciated that other planting data, such as, for example, soil type and/or composition, generic composition of the crop, treatment data (e.g., fungicides, fertilizes, herbicides, etc., applied to the field 106 and timing thereof), etc. may also be included in the database 104.

The weather data included in the database 104 may be received from, retrieved from, provided from, etc. a number of different sources (e.g., local weather services, the national weather service, etc.). The weather data may include, without limitation, solar radiation data, temperatures, precipitation, dew point, windspeed, and other details related to the weather at or associated with the field 106 at various times, dates, intervals, etc. The weather data may be specific to the location or region including the field 106 (or another location or region) based on, for example, geolocation data (e.g., as defined by longitude/latitude data for a centroid of the field 106 or for a group of fields including the field 106, or for a region including the field 106, etc.), or it may be specific to a general size of a region including the field 106 (e.g., a 4000 square meter area or region, or less or more, etc.), whereby the field 106 and each other field within the region is associated with the weather data. Alternatively, when the field 106 is in multiple regions, the weather data for the multiple regions may be averaged, aggregated, or otherwise joined or combined (equally or based on proportion of the field 106 in each region, or otherwise) in connection with the operations/steps described herein, etc. The weather data may be hourly, semi-hourly, daily, or at another suitable and/or available interval, etc.

It should be appreciated that the weather data prior to a specific date will include actual weather data, as recorded, for example, by a weather service, etc. And, weather data after the specific date will generally include predicted, forecasted, etc. weather data. Actual weather data may include weather data for a current season, and also for various prior seasons or years. In addition, the weather data may include predicted weather data for a specific date, or range of dates, etc. As such, for a period of time, the weather data may include a combination of actual weather data, forecasted weather data, and then also historical year weather data (e.g., climatology data, etc.), where the historical year weather data may be based on one or more prior seasons or years. In connection therewith, the historical year weather data may mainly be used for historical year records. For example, during a current year, for a period of weeks (e.g., 19 weeks from planting to predicted harvest, etc.), the weather data for a specific date may include three weeks of actual data for the season, two weeks of short term forecasted data (e.g., forecasted weather data based on contemporaneous conditions, etc.) and then 14 weeks of climatology data (e.g., including an average of temperature, dew point, etc., per day of the last 10, 15, 30 or more or less years, etc.). Consequently, it should be understood that, as the specific date extends later in the season, the more actual weather data for the season is used.

Apart from the planting and weather data, the database 104 also includes one or more growth stage models. An example growth stage model may be understood from co-pending U.S. Provisional Application No. 63/399,534, filed on Aug. 19, 2022, which is incorporated herein by reference. The model(s), in general, provides a specific growth stage of a crop for a given day or date. As such, for example, for a given planting date, the model, in this embodiment, configures the computing device 102 (in a particular manner to then operate in a specific, unique way as described herein), to identify the date/day at which the crop in the field 106, which is soybeans in this example, will achieve each of the growth stages listed in Table 1, for example.

In this example embodiment, the database 104 further includes historical quality data for the field 106 and various other fields (not shown), and for the crop(s) in the field 106 (and other fields). The historical quality data includes the quality of the seeds or crop harvested from the field 106 and other fields. The quality may be expressed semantically by terms such as good, excellent, poor, etc., or numerically by an integer or other number indicative of the quality (relative to one or more scales, etc.) (e.g., an actual germination score, a ratio of good to poor, etc.). The quality may include a variety of different ranges or classifications, etc. In general, the granularity of the quality data included in the database 104 will be consistent with the quality indicator predicted, generated, compiled, determined, etc. herein.

It should be appreciated that corresponding weather data and planting data for the fields (e.g., including the field 106, etc.), and the specific seasons (e.g., growing seasons of crops in the fields, etc.), are also included in the database 104, thereby defining training data for modeling of the quality of the crops in various fields (including the crop in the field 106) (e.g., training data for a quality model or quality prediction model herein, etc.). The training data is generally separated into a training set and a validation set, where the separation may be random or based on one or more criteria (e.g., partial years, alternate years, etc.).

As indicated above, the computing device 102 is configured to access data from the database 104 as desired, or when desired, to implement the features of the present disclosure. In this example embodiment, the computing device 102 is configured to access the training data (as part of a training data set) and the validation data (as part of a validation data set), which, in turn, includes the appropriate planting data, weather data, and historical quality data (e.g., for the field 106 and crop(s) therein, for other fields, etc.). The computing device 102 is configured to also access a growth stage model, from the database 104, for the particular crop in the field 106 (and/or for other crop(s) associated with the accessed data, etc.). In this example, the crop in the field 106 is soybeans, as indicated above, whereby the model or models accessed by the computing device 102 are associated with (or are specific to) the growth stages of soybeans, as indicated in Table 1, for example.

It should be appreciated that the training and validation data each include data representative of dozens, hundreds, or thousands of fields (e.g., 200 fields or more or less, 2000 fields or more or less, etc.), over one or multiple seasons and included in one or multiple different regions. In this example embodiment, each of the fields for the data is associated includes soybeans, as is the target crop in this example, in general, and may even include a specific variety of soybeans. In general, the data will be particular to the target crop included in the target field 106 (or crop of interest, etc.).

Initially, the computing device 102 is configured to limit or filter the fields in the accessed training data and validation data (e.g., for reasons of field sampling and validation, etc.), based on, for example, maturity ranges; environmental classification zones grouped by similar environmental and topographical factors, such as, for example, elevation, slope, aspect, heat load index, available water capacity, geographic locations (e.g., along a consistent latitude, within a radius of a centroid of a region (or a target field), etc.), etc.; etc. It should be appreciated that other suitable criteria may be used to filter the data included in the training and validation data sets. That said, filtering may be extended or limited in various embodiments, to enhance the accuracy of the model and/or to maintain a broader use of the trained model.

Once filtered, the computing device 102 is configured to determine, for each maintained field (in the training data set and the validation data set), dates of the growth stages relative to the planting date of the field associated therewith, by use of the growth stage model(s) (included in the database 104, etc.). The growth stages, as indicated above, are generally expressed as V3, V4, etc., for example, along with the corresponding dates/days of the stages, etc. The computing device 102 may be configured to combine different growth stages in some embodiments (e.g., V4-V6, etc.), or to maintain the granularity of the growth stage output from the model(s).

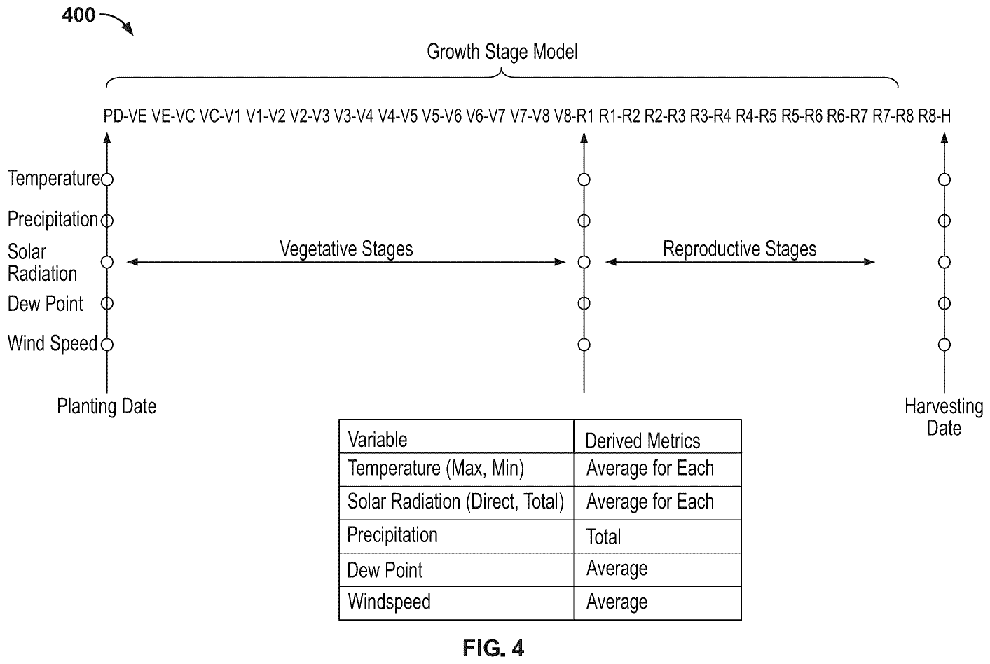

Next, the computing device 102 is configured to associate weather data for each field, from the accessed data, consistent with the growth stages (as shown in progression 400 of FIG. 4).

Specifically in the illustrated embodiment, and without limitation, the computing device 102 may be configured to associate average maximum/minimum temperatures, average direct/total solar radiation, average dew point, total precipitation, average wind speed, etc. (broadly, features or variables) for each field. For example, where growth stages R1-R2 extend for five days, the computing device 102 is configured to combine the weather data for the five days to determine, for example, the average, median, medium, maximum/minimum, etc. value(s), or to otherwise combine the weather data for the five days. As such, for example, a growth stage of R1-R2 may be associated with an average minimum temperature of about 15° C., an average maximum temperature of about 26° C., and an average dew point of about 16° C., and further may be associated with an average total solar radiation of about 24 MJ/m² and a total precipitation of about 58 mm. It should be appreciated that these specific values are illustrative (and example in nature), and that other values may be associated with the specific growth stages. In addition, it should be appreciated that other features/variables may be used in other embodiments, for example, one or more of a dew point temperature (° C.) at a growth stage of R5-R6, a maximum temperature (° C.) at a growth stage of R5-R6, a dew point temperature (° C.) at a growth stage of R2-R3, a dew point temperature (° C.) at a growth stage of R6-R7, a wind speed (m/s) at a growth stage of R7-R8, a dew point temperature (° C.) at a growth stage of R3-R4, a minimum temperature (° C.) at a growth stage of R5-R6, a wind speed (m/s) at a growth stage of R6-R7, a week of planting, a day of planting, etc.

What's more, it should also be appreciated that the features/variables relied on herein may extend beyond weather data, including, for example, to soil type, management practice, etc. As such, the description herein may utilize one or more features/variables relating to weather data, soil type, management practice, or combinations thereof, etc. The computing device 102 is then configured, as indicated above, to associate these values to the corresponding growth stage, for each growth stage of the crop, for each field in the training and validation data sets (or, alternatively, identify these variables for particular growth stages). That said, the features/variables described herein may be evaluated for importance relative to the particular determination/calculation to be made, whereby certain features may be more important (or weighted more) than others for given determinations/calculations. In addition, the features herein may be combined as desired (e.g., via the given model, etc.) or assessed differently based on, for example, a type of data source from which the features (or related information) is derived or received or retrieved.

The computing device 102 is in turn configured to train a quality model, for example, based on the combined weather-growth stage data and the historical quality data, in order to output a germination score (e.g., a warm germination score, etc.) for the fields (and/or for the crops in the fields). In this example embodiment, the quality model incudes a random forest model, in which decision trees are trained consistent with the data. As described in more detail in the method 300, the decision trees are trained to split the data of the dataset(s) smaller and smaller to predict a target value (e.g., excellent seed quality/poor seed quality determined by warm germination score, where each maturity group relies on different thresholds to determine seed quality; etc.). Certain rules and/or criteria may stop the splitting process (e.g., the maximum depth of the tree is reached, or no further information gain, etc.). After a defined number of decision trees are built, the computing device 102 is configured to combine the predictions from the trees to make the final prediction. Depending on the type of target value (for the predication), a mode of classes is used for classification and a mean prediction is used for regression. Specifically, the trained model utilizes the mode of the classes from multiple decision trees to predict seed quality, which is defined by thresholds based on different maturity groups.

It should be understood that the germination score, from the quality model, is indicative of quality of the seed when combined, for example, with one or more maturity ranges. For example, for a maturity range or group of 0-4, a germination score of greater than or equal to threshold A may be an excellent or standard quality (and moderate or poor otherwise), while for a maturity range of greater than 4, a germination score of greater than or equal to threshold B may be an excellent or standard quality (and moderate or poor otherwise). It should be appreciated that threshold A and threshold B may be a variety of different values, whereby each is indicative of a threshold of quality (e.g., based on business rules, industry norms, grower expectations, etc.), etc.

Once the quality model is trained, the computing device 102 is configured to predict the quality of seeds (or crop(s)) in the validation data set, whereby the computing device 102 is configured to provide the weather data per growth stage to the trained model as an input, and the computing device 102 is configured to compare the output of the trained model to the corresponding quality included in the validation data set, either directly or via a further computation (e.g., combination with maturity group, etc.).

When the trained quality model is validated, i.e., where sufficient accuracy is demonstrated, the computing device 102 is configured to store the model in the database 104 for use in predicting quality of soybean fields.

For instance, in the illustrated embodiment, with the trained model, the computing device 102 is configured to predict quality of seeds or crop currently in the field 106, at a time prior to harvest, for example. The prediction may be initiated based on a planting date, or may be initiated or re-initiated at a later time, etc. In this example, the computing device 102 is configured to predict the quality of the seeds or crop currently in field 106 at a time after the planting date (e.g., about one week after the planting date, about two weeks after the planting date, about four weeks after the planting date, at other times after the planting date, etc.), yet prior to one or more harvest operations, or prior to other operations impacted by a quality of the seeds or crops in the field 106 (or prior to one or more decisions to plant seeds in a given field in a following year, etc.).

In connection therewith, the computing device 102 is configured to access the planting data for the field 106, and also weather data for the field 106. The weather data may include actual data for the present season (i.e., when the crop to be harvested is planted in the field 106), forecasted data, and historical or climatology data for the field 106, specifically, or for one or more regions in which the field 106 is located, over multiple previous years (e.g., averaged and/or totaled over the most recent several years, etc.). It should be appreciated that any combination of actual, historical and forecasted weather data may be used herein. In addition, in at least one embodiment, the forecasted weather data may be omitted, while in another embodiment, the forecasted weather data may be used for prior days when the actual weather data is not yet up to date or not yet available. In addition, it should be appreciated that different weather data, among the actual, forecasted, and historical data, may be used for different weather data for the same day or period. For example, forecasted weather data for an average maximum/minimum temperature and/or a maximum/minimum temperature may be included for a given day, while the historical weather data for dew point or wind speed may be included for that same day in the weather data. That said, it should be appreciated that all weather data, for example, for a given day, etc., may be included from the same type, i.e., actual, forecasted, and/or historical, etc.

Based on the weather data and the planting data (e.g., planting date, field and/or crop images, etc.), the computing device 102 is configured to determine, based on the growth stage model(s), the timing of the growth stages of the field 106 up until harvest, for example. Like the above, then, the growth stages are each indicated for certain future day(s) (and past day(s)) of the field 106. The computing device 102 is then configured to aggregate the weather data according to the growth stages, as explained above.

In this example embodiment, the computing device 102 is configured to next compute, based on the trained random forest model, in this example (broadly, the trained quality model), the germination score of the field 106 (or crop or seeds therein). The computing device 102 is configured to then determine a quality of the crop or seeds, based on a correlation between the maturity group of the crop in the field 106 and the germination score. For example, consistent with the above, for a maturity range or group of 0-4, the computing device 102 may be configured to identify a quality of excellent or standard for the crop when the germination score of greater than or equal to threshold A, or moderate or poor when the germination score is less than the threshold A. Similarly, for a maturity range or group greater than 4, the computing device 102 may be configured to identify a quality of excellent or standard or moderate for the crop when the germination score of greater than or equal to threshold B, or poor when the germination score is less than the threshold B.

It should be appreciated that various different qualities (more than four, less than four) may be identified by the computing device 102 based on the modeled germination score and/or maturity groups of the crop included in the field 106.

In turn in the system 100, based on the identified quality, the computing device 102 is configured to direct or impose at least one harvest operation for the crop or seeds in the field 106. For instance, the system 100 may transmit an instruction to a computing device of the agricultural machine 108 (e.g., a combine, etc.), and/or to a user associated with the agricultural machine 108, whereby in response to the instruction, the agricultural machine 108 operates (e.g., directly in response to the instruction, based on operation by the user, etc.) within the field 106 to harvest the crop. In doing so, the agricultural machine 108 may collect the crop from the field 106 (e.g., cut soybean plants from the field 106, etc.) and separate the grain from the collected crop (e.g., separate the soybean from the collected soybean plant, etc.). In connection therewith, in one example, the computing device 102 is configured to further designate a particular bag 110 and/or tag 112, having an associated quality, for use in receiving the harvested crop from the field 106. In another example, the computing device 102 may be configured to define a harvest timing for the field 106, and in particular, direct the agricultural machine 108 to harvest the field 106, based on the quality of the field 106 and the quality of other fields (e.g., to set priorities or conditions to maintain or enhance the overall quality of the crops harvested from the fields, etc.). In yet another example, the directing of the harvest operation may include displaying the quality of the target field 106, and other fields, to a user or grower in connection with harvest planning, resource allocation, etc.

In at least one embodiment, the computing device 102 may be configured to direct or impose one or more non-harvest operation(s) for the crop or seed in the field 106 based on the identified quality of the crop or seed in the filed 106. For example, the computing device 102 may be configured to impose a treatment on the field 106 based on the quality, etc. (e.g., a fertilizer treatment, a pesticide treatment, an irrigation treatment, etc.).

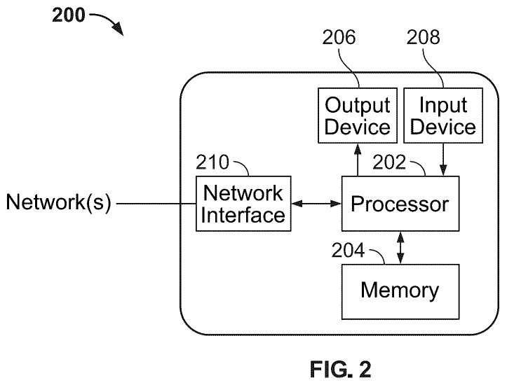

FIG. 2 illustrates an example computing device 200 that may be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to operate as described herein. In the example embodiment of FIG. 1, the computing device 102 and the agricultural machine 108 includes and/or is implemented in one or more computing devices consistent with computing device 200. The database 104 may also be understood to include and/or be implemented in one or more computing devices, at least partially consistent with the computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including, without limitation, models, weather data (e.g., actual data, forecast data, historical data, etc.), planting data (e.g., soil type, etc.), quality data, management practices, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202 (e.g., a presentation unit, etc.). The output device 206 may output information (e.g., growth stage data, quality data, etc.), visually or otherwise, to a user of the computing device 200, such as a researcher, grower, technician, etc. It should be further appreciated that various interfaces (e.g., as defined by network-based applications, websites, etc.) may be displayed or otherwise output at computing device 200, and in particular at output device 206, to display, present, etc. certain information to the user. The output device 206 may include, without limitation, a liquid crystal display (LCD), a light-emitting diode (LED) display, an organic LED (OLED) display, an “electronic ink” display, speakers, a printer, etc. In some embodiments, the output device 206 may include multiple devices. Additionally or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of crops, selections of fields, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment the input device 208 may be integrated and/or included with the output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including suitable network capable of supporting wired and/or wireless communication between the computing device 200 and other computing devices, including with other computing devices used as described herein (e.g., between the computing device 102, the database 104, etc.).

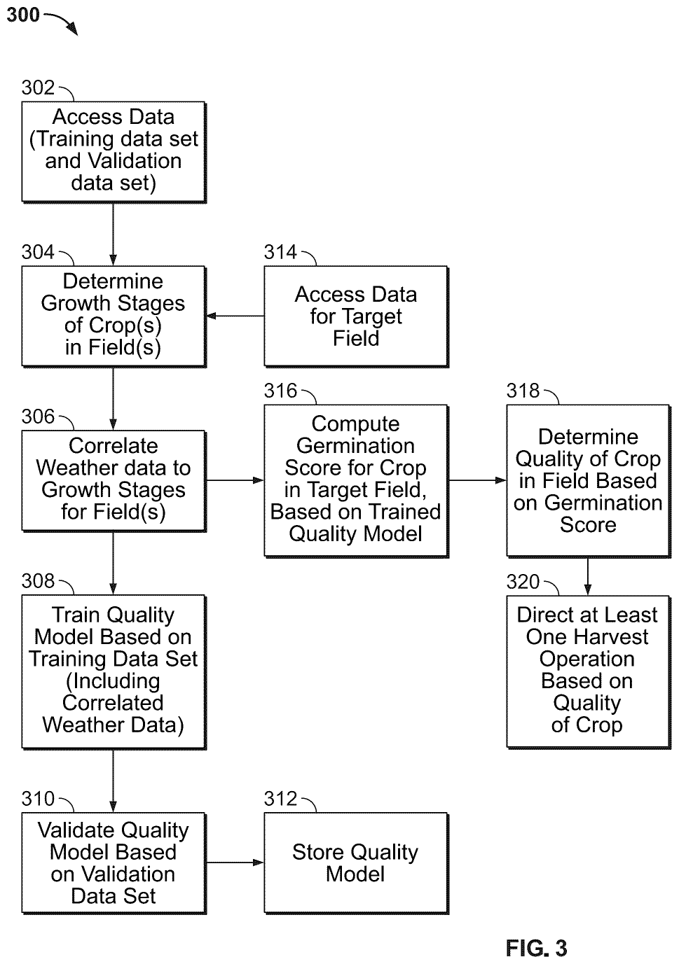

FIG. 3 illustrates an example method 300 for providing (e.g., prioritizing, etc.) harvest operation(s) for a crop, in a manner consistent with a predicted quality of the crop. The example method 300 is described herein in connection with the system 100, and may be implemented, in whole or in part, in the computing device 102 of the system 100. Further, for purposes of illustration, the example method 300 is also described with reference to the computing device 200 of FIG. 2. However, it should be appreciated that the method 300, or other methods described herein, are not limited to the system 100 or the computing device 200. And, conversely, the systems, data structures, and the computing devices described herein are not limited to the example method 300.

At the outset, it should be appreciated that the method 300 is directed, in the description below, to the field 106 in the system 100. However, the method 300 may be applied to additional fields, or different fields, or parts thereof, plots thereof, etc., in other method embodiments, whereby, for example, the quality of the crops and/or seeds associated with the crops is determined across various fields associated with the same grower, or otherwise related and/or linked, or not.

Initially, at 302, the computing device 102 accesses data from the database 104, where the accessed data includes a training data set and a validation data set for use in training and validating a random forest model (broadly, a quality model). The training data set includes data representative of a number of fields (which may or may not include the field 106), which may be identified to the training data set by location, maturity group, crop type, crop variety, and/or randomly, etc. For example, crops with different maturity groups are planted across the United States, where the maturity group increases, for example, as the crop is planted from North Dakota down to Tennessee, and whereby the maturities (and also crop type or crop variety) may be limited to promote the accuracy of the training (when a sufficient size of data is provided). In addition, the training data set includes historical quality data for the multiple fields, over one or more seasons (or years), along with corresponding weather data for the location of the fields for time periods associated with planting of the fields to harvest (and beyond).

The computing device 102 then determines, at 304, the growth stages for the crop(s), which may be included in the training set of data, or which may be separately determined from a specific date in the growing season for the crop(s). For example, the historical data, such as, for example, the planting data, may include date specific growth stages for the historical fields, which indicate the day(s), relative to the planting date for the fields, at which each growth stage occurred. Alternatively, or additionally, the computing device 102 may employ a growth stage model (as generally described above) to model the growth stages for the fields, from a specific date (e.g., an early growth stage date, a planned date to predict quality, etc.), from which the remaining growth stages (and potentially, prior growth stages) are predicted and/or defined.

Accordingly, a data structure is generated, which includes each of the growth stages, for the crop(s), such as, for example, soybean crops (e.g., as shown in Table 1, etc.), and the dates of the growth stages per field, for the historical training data set.

With the growth stages, the computing device then, at 306, correlates the growth stages with the weather data (e.g., for each of the identified fields, etc.). In particular, for example, the computing device 102 retrieves the weather data for the different growth stages based on the location of the given field associated with the training data set (or locations of the fields) (e.g., a centroid of each of the fields, etc.) or region(s) including the field 106, relative to a source or boundary associated with the weather data. The computing device 102 further aggregates the weather data (e.g., actual weather data, forecasted weather data, historical weather data, etc.) for each of the growth stages. For example, where a growth stage spans five days, the computing device 102 may average the temperature (or solar radiation) over the five-day growth stage. In another example, where a growth stage is ten days, the computing device 102 may aggregate the precipitation by summing the precipitation up to (and/or through) the growth stage.

It should be appreciated that other manners of aggregating the weather data, for example, based on the type of the weather data, etc., may be employed. Example aggregation of the identified weather data is provided in FIG. 4.

In one or more embodiments, it should be appreciated that the growth stages may be separate or aggregated (e.g., in one or more groups, etc.), and correlated with weather data for the separated and/or aggregated growth stages.

Next in the method 300, at 308, the computing device 102 trains the quality model based on the correlated weather data and the historical quality data, such as, for example, the warm germination score, etc. In particular, the computing device 102 accesses weather data aggregated by growth stages for multiple years for specific fields and/or regions in which field(s) are located and also corresponding historical quality data (e.g., warm germination scores, etc.). Training, then (as generally described above) relies on various decision trees, which train on a slightly different set of the historical records (randomly selected with replacement) and different sets of weather associated variables (e.g., one decision tree may randomly choose precipitation aggregated by growth stages R5-R6, maximum temperature aggregated by growth stages V1-V2, etc., while another decision tree may randomly choose solar radiation aggregated by growth stages V3-V4, and dew point aggregated by growth stages V4-V5, etc.). Of course, other trees may choose other weather variables and/or other growth stages (and/or ranges of growth stages), alone or in combination. For instance, other trees may choose one or more other (or additional) variables such as a dew point temperature (° C.) aggregated by growth stages of R5-R6, a maximum temperature (° C.) aggregated by growth stages R5-R6, a dew point temperature (° C.) aggregated by growth stages R2-R3, a dew point temperature (° C.) aggregated by growth stages R6-R7, a wind speed (m/s) aggregated by growth stages R7-R8, a dew point temperature (° C.) aggregated by growth stages R3-R4, a minimum temperature (° C.) aggregated by growth stages R5-R6, a wind speed (m/s) aggregated by growth stages R6-R7, a week of planting, a day of planting, etc. That said, and as described above, the features/variables to be used (e.g., the features/variables described herein, one or more other features/variables (weather based or not), etc.) may be evaluated for importance relative to the particular determination/calculation to be made (e.g., via a feature importance chart, etc.), whereby certain features may be identified as more important (or weighted more) than others for given determinations/calculations (e.g., taking into account the particular model being used to predict crop quality, etc.). In addition, the features/variables herein may be combined as desired or assessed differently based on, for example, a type of data source from which the features (or related information) are derived or received or retrieved.

To determine the desired number of decision trees, the number of weather associated variables to be tested in each tree node, and the minimum number of data points in each node, a grid search is used to perform hyperparameter tuning in the random forest model (broadly, in the quality model). For example, five hundred decision trees, one thousand decision trees, fifteen hundred decision trees, more or less decision trees, etc. may be tested in the model, and the best combination of hyperparameters are selected by prediction accuracy of the trained model. Each decision tree splits historical records in each node into smaller and smaller datasets while considering the randomly selected weather variables. The splitting process is done by evaluating certain metrics (e.g., Gini index, mean squared error, residual, etc.). In one particular embodiment, the Gini index was employed to represent node impurity. In doing so, the Gini index may be defined via the below equation:

Gini=1−Σᵢ₌₁^{C}(Pᵢ)²

In this equation, Pᵢ is the probability of a quality (e.g., excellent or poor, etc.) being classified for a distinct class. A high Gini index score generally represents higher impurity in the node.

As part of the training, each decision tree continues growing/splitting until a growth-stop condition is met (e.g., a desired maximum depth of the tree, a minimum number of samples in the nodes, or a minimum reduction in the error metrics, etc.). After the decision trees are built, random forest combines the prediction results from the decision trees, and the mode of classes is used to represent the final prediction results.

Feature importance is then calculated through each decision tree. For each decision tree, the node importance is determined using the Gini index, assuming two child nodes after one parent node, as provided below:

nodeⱼ₍ᵢₘₚ₎=wⱼ₍ₚ₎Gⱼ₍ₚ₎−w_{j(left)}G_{j(left)}−w_{j(right)}G_{j(right)}

In doing so, nodeⱼ₍ᵢₘₚ₎ is the importance of the node j; wⱼ₍ₚ₎ is the weighted number of samples/data points reaching parent node j; Gⱼ₍ₚ₎ is the gini index (impurity value) for parent node j; w_{j(left)}/w_{j(right)} is the weighted number of sample/data points reaching left/right child node which split from parent node j; and G_{j(left)}/G_{j(right)} is the Gini index (impurity value) for left/right child node which split from parent node j.

The feature importance in the decision tree is then calculated by:

$${feature}_{i ( i m p )} = \frac{{Σ}_{node j splits on feature i} {node}_{j ( i m p )}}{{Σ}_{k ∈ all nodes} {node}_{k ( i m p )}}$$

Here, featureᵢ₍ᵢₘₚ₎ is the importance of feature i; and nodeⱼ₍ᵢₘₚ₎ is the importance of the node j.

Final importance for the random forest, then, is the average over all of the decision trees:

$${RFfeature}_{i ( i m p )} = \frac{{Σ}_{k ∈ all trees} {feature}_{i k ( i m p )}}{total number of trees}$$

Here, RFfeatureᵢ₍ᵢₘₚ₎ is the importance of feature i calculated from all decision trees in the random forest; and featureᵢₖ₍ᵢₘₚ₎ is the importance of feature i on tree k.

Based on such feature importance calculation, the random forest model indicates or identifies, in this example embodiment, that dew point, minimal temperature, maximum temperature, wind speed during reproductive stages and/or day of planting/week of planting, etc., as being important features to affect soybean quality, for example.

In the training data set, because the quality (e.g., warm germination scores, etc.) is across historical records, there exists an imbalanced scenario where a number of excellent quality records is much greater than a number of poor quality records. The quality model, in this example, employs Synthetic Minority Oversampling Technique (SMOTE) to oversample the minority class, specifically the poor quality records in this example, by generating synthetic instances. For each poor-quality sample, five or other suitable number of nearest neighbors to the sample are determined, in this example, by Euclidean distance from other poor-quality samples. The new synthetic instances then are generated by the following equation, which represents one poor-quality sample from the five nearest neighbors.

x_{new}=x+rand(0,1)*(\tilde{x}−x)

Here, the expression rand(0,1) represents a random number between 0 to 1.

In this manner, a profile of the training data set, i.e., the imbalance between excellent and poor quality samples is improved, via SMOTE. The computing device 102 then validates, at 310, the quality model, based on the validation set. As part thereof, the computing device 102 computes qualities based on the planting data and weather data included in the validation set, via the trained quality mode, and then compares the computed qualities to the corresponding qualities in the validation set. When the performance of the trained quality model is above a threshold, the model is stored, by the computing device 102, at 312, in the database 104 for later use. For example, the threshold may include, without limitation, about 75%, about 80%, about 85% or about 90% of accuracy (e.g., for both positive cases and negative sample, etc.) and about 75%, about 80%, about 85%, about 90% or about 95% precision, etc.

Thereafter, in method 300, the quality model is suitable to be used to determine a quality of a crop, in season, in the field 106, for example (also referred to herein as a target field, etc.). In general, the quality model is usable in the field 106 or similar field, for example, in the same region, etc. In connection therewith, specifically, at 314, the computing device 102 accesses data for the target field (i.e., field 106, etc.), including, for example, weather data and planting data, in connection with a request to determine the quality of the crop or seeds in the field 106. The request may be received, for example, at planting or at one of a particular vegetative growth stage (e.g., V7 or V8, etc.), or just prior to harvest of the crop from the field 106, or earlier or later. The request may be provided in the form of an electronic message from the grower (e.g., an email, a SMS message, via a mobile application, or via a web interface input, etc.). It should be appreciated that the request may be sent automatically, based on planting data and/or may be repeated at one or more regular or irregular intervals, etc. The planting data may include image data for the field 106 and/or the crop(s) in the field 106, planting date(s) for the crop(s) in the field 106, etc.

Next, at 304, the computing device 102 determines, consistent with the above, the growth stages of the crop(s) in the target field 106. In this instance, the growth stages are predicted based on one or more growth-stage models (at least partially) because the determination of the quality is occurring in-season (i.e., prior to harvest of the crop). As explained, the computing device 102, accordingly, determines (via the growth-stage model(s)) the interval of the growth stages, in days, for example, relative to the planting date of the crop in the target field 106.

FIG. 4 illustrates a progression 400 of the growth stages for soybean, consistent with Table 1. As shown, the growth stages range from the planting date at PD to a harvesting date at H, along with numerous different stages therebetween. In connection therewith, the progression 400 illustrates relation of a given growth stage model to in-season growth windows, for example, for use in calculating weather related predictive variables, etc. The windows used to calculate the in-season weather variables may be determined by breaking down the life cycle, from planting to harvesting, of the given crop in each of the fields into several growth stages, for example, using vegetative dates simulated by the given growth stage model.

Referring again to FIG. 3, the computing device 102 then correlates, at 306, the weather data for the target field 106 to the growth stages. The weather data in general includes actual weather data for the specific season for some or all of the prior growth stages, in time. It should be appreciated that actual weather data may not be available for most recent days, hours, etc., based on a source of the weather data in some embodiments, but may be available in other embodiments. In addition to the actual weather data, the weather data may generally include historical weather data from prior seasons for the target field 106 (or its location), specifically or generally, for example, for the region, for other growth stages. The historical data may be aggregated over seasons, whereby the temperature, for example, over the last decade(s) or more or less, may be averaged for each of the days in a growth stage or otherwise obtained.

Also, the weather data may include forecast data for the target field 106, which may include a five, seven, ten, etc., days of data (or more of less) based on present forecasts for the interval (e.g., in lieu of relying on historical weather data, or actual weather data when unavailable, etc.).

That said, with reference to FIG. 4, the weather data (or weather variables) may include, for example, temperature, precipitation, solar radiation, dew point and wind speed. However, it should be appreciated that other combinations of weather data may be used in other example embodiments.

Referring again to FIG. 3, next in the method 300, at 316, the computing device 102 employs the trained quality model to compute a quality of the crop in the target field 106, which, in this embodiment, includes computing a germination score for the crop. The germination score (which is being computed herein) is generally the germination percentage reported on the seed tag of commercially sold seed. Specifically, the germination score represents the seed being germinated in nearly ideal conditions, where the germination score is then the number to represent the viability of seed lots including the seed.

In turn, the computing device 102 determines, at 318, the quality of the crop in the target field 106, based on the germination score and a maturity of the crop. Such determination, in this example, is also independent of a physical examination of the crop in the target field 106. In determining the quality of the crop, the computing device 102 may, for example, define different maturity groups or ranges of maturity groups, and then, one or more thresholds for the maturity groups. As such, the maturity of the crop may fall within the range of maturity groups 1-4, for example, whereby the germination score may be compared to a threshold of about 0.915, where the crop is determined to have an excellent or standard quality when the germination score is at or above the threshold, and conversely, the crop is determined to have a poor or moderate quality, when the germination score is below the threshold. It should be appreciated that multiple thresholds may be included for a maturity group or range, whereby the quality may be distinctly excellent, standard, moderate or poor, or associated with any other sematic quality.

Table 2 illustrates an example correlation between maturity (e.g., relative maturity (RM), maturity group (MG), etc.) and germination score for soybeans, whereby the computing device 102 may determine, or assign, a quality of the crop (e.g., based on germination score or otherwise, etc.). It should be understood that RM indicates the crop's maturity in relationship to other soybeans, for example, while MG assess the length of time from planting to physiological maturity (which may be just prior to harvest).

TABLE 2

| RM Based | ½ MG Based | Excellent | Standard | Moderate | Poor |
|---|---|---|---|---|---|
| 0.0-4.5 | 0.0-4 | >95 | 91.5-95 | 86.5-91.5 | <86.5 |
| 4.6+ | 4.5+ | >92 | 86.5-92 | 81.5-86.5 | <81.5 |

In at least one embodiment, the determined quality is a numeric representation of quality, or is categorically based on defined thresholds (e.g., excellent, good, poor, etc.), or otherwise indicative of a relative quality among a variety of crops and/or seeds.

The quality of the crop in the target field 106 may be used in a number of different manners, through use of the determined quality directly by the computing device 102, the agricultural machine 108, or a user or grower to which the quality is displayed or otherwise communicated, for example, by the computing device 102. In the method 300, as shown in FIG. 3, the computing device 102 directs, at 320, at least one harvest operation based on the quality determined thereby.

For example, the harvest operation (as directed by the computing device 102) may include designating a bag or a tag for the harvested crop based on the quality. In this example, the tag may indicate a specific quality: standard, excellent, moderate, etc., or the tag may be integrated into the bag and include the same information. Alternatively, the tag may include a particular value associated with the given quality, for example, a germination score, etc. The harvest operation may further include the actual harvest, whereby the agricultural machine 108 is directed to harvest the crop at a time indicated by the quality of the crop in the field 106. The timing may be specific to the field 106, or may be specific to numerous fields, whereby the harvesting is ordered and/or directed for the fields, relative to other fields, based on the different qualities of the crops in the different fields. For example, field 106 may be prioritized over other fields when it is determined to have a poor or moderate quality, or deprioritized over other fields when it is determined to have an excellent quality.

It should be appreciated that other harvest operations may be directed based on the quality of the fields, as determined consistent with method 300, whether related specifically to harvest or otherwise. In one example, when a quality is determined in an earlier growth stage, or at least some interval prior to harvest, the agricultural machine 108 may include a particular treatment (or irrigation) apparatus, and be directed, based on the quality of the field 106, as determined through method 300, to treat (or irrigate) the field in an attempt to alter the quality of the field by the time of harvest. Other operations, related to harvest or not should also be considered to be within the scope of the present disclosure, as a physical act or step in the field 106 (and other fields) to affect the operation of the growth of crops in the field 106 and other fields.

Still further, at 320, the computing device 102 may direct at least one other operation (e.g., other than an operation of actually harvesting, treating, etc. the crop in the field 106; etc.) relating to the field 106 (and/or other fields) and/or the crop in the field(s) based on the quality determined thereby. For instance, the computing device 102 may direct extension of one or more contracts during a present growing season of the crop in the target field 106, in response to defined portions of the target field being of a certain quality.

Additionally, or alternatively, the computing device 102 may direct (e.g., provide an instruction, provide a recommendation, etc.) a particular planting instruction for the field 106 for a following growing season (e.g., for a growing season of the field 106 following harvesting of the crop from the field 106, etc.). Such instruction may be based on the determined quality of the crop in the field 106 in the current growing season. For example, the computing device 102 may direct planting the same crop in the field 106 in the following growing season (e.g., where the determined quality of the crop in the field 106 in the current growing season was in a particular category or satisfied a particular threshold, etc.); may direct not planting the same crop in the field 106 in the following growing season (e.g., where the determined quality of the crop in the field 106 in the current growing season was in a particular category or failed to satisfy a particular threshold, etc.); may direct planting a different crop in the target field in the following growing season; or may direct not planting any crop in the target field in the following growing season.

In view of the above, the systems and methods herein may provide harvest operation(s) for a crop, in a manner consistent with a predicted quality of the crop. In particular, for example, harvest time might be adjusted by the predicted quality by target fields and other fields. Additionally, or alternatively, treatments may be implemented, adjusted, etc. by the predicted quality for the target fields (and other fields). Further, the systems and methods herein may provide early indicators to growers and planners with regard to crops, for example, whereby the growers and planners may understand which fields are potentially good quality fields and which fields are potentially poor quality fields before harvest. In response, the planners and growers may alter planting operations to avoid growing seeds in the frequently poor quality fields. Moreover, planners and growers may prepare bag labels before harvest based on the indicated quality, thereby saving the time and cost of retagging and/or re-bagging units of seed. Furthermore, through the systems and methods herein, growers may prioritize their harvest, so that poor predicted fields may be harvested earlier than good predicted fields thereby avoiding further seed damages.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing data associated with a crop in a target field, the data including planting data for the crop and weather data for the target field; (b) correlating the weather data to each of a plurality of growth stages for the crop in the target field; (c) determining the plurality of growth stages of the crops, based on a planting date and a maturity group of the crop in the target field from the planting data; (d) prior to a harvest of the crop from the target field, determining a quality of the crop in the target field, based on the correlated weather data and a quality model specific to a type of the crop and independent of a physical examination of the crop in the target field; (e) training the quality model based on a training set of data, the training set of data including, for a given time period and multiple fields, weather data, planting data and quality data for harvested crops from the multiple fields; and/or (f) directing at least one agricultural operation consistent with the determined quality of the crop in the target field.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing agricultural operation(s) for a crop in a target field, based on a determined quality of the crop in the target field, the method comprising:
accessing, by a computing device, data associated with a crop in a target field, the data including planting data for the crop and weather data for the target field;
correlating, by the computing device, the weather data to each of a plurality of growth stages for the crop in the target field;
prior to a harvest of the crop from the target field, determining, by the computing device, a quality of the crop in the target field, based on the correlated weather data and a quality model specific to a type of the crop and independent of a physical examination of the crop in the target field; and
directing at least one agricultural operation consistent with the determined quality of the crop in the target field.

2. The computer-implemented method of claim 1, wherein the planting data includes a planting date of the crop in the field, a relative maturity of the crop, and/or a location of the target field;
wherein the weather data includes a temperature, a dew point, a precipitation, a solar radiation, and/or a windspeed for the target field per interval; and
wherein the interval includes a day.

3. The computer-implemented method of claim 1, further comprising determining the plurality of growth stages of the crops, based on a planting date and a maturity group of the crop in the target field from the planting data; and
wherein each growth stage is associated with a number of days from the planting date.

4. The computer-implemented method of claim 1, wherein correlating the weather data to each of the plurality of growth stages includes aggregating, by the computing device, the weather data for each of the plurality of growth stages.

5. The computer-implemented method of claim 4, wherein aggregating the weather data includes:
averaging temperature data from the weather data for each of the growth stages; and/or
summing precipitation data from the weather data for each of the growth stages.

6. The computer-implemented method of claim 1, further comprising:
training, by the computing device, the quality model based on a training set of data, the training set of data including, for a given time period and multiple fields, weather data, planting data and quality data for harvested crops from the multiple fields; and
validating, by the computing device, the quality model, prior to determining the quality of the crop in the target field.

7. The computer-implemented method of claim 1, wherein the weather data for the multiple fields includes actual weather data; and
wherein the accessed weather data for the target field, or a region in which the field is located, includes a combination of at least two of: actual weather data for a present season, forecasted weather data, and historical weather data for prior seasons.

8. The computer-implemented method of claim 1, wherein directing at least one agricultural operation includes designating a tag and/or a bag specific to the determined quality of the crop in the target field to be used in bagging the crop at harvest of the crop from the target field.

9. The computer-implemented method of claim 1, wherein directing at least one agricultural operation includes directing an agricultural machine to harvest the crop form the target field at a specific time indicated by the determined quality of the crop in the target field and/or by multiple qualities determined for other fields associated with a grower of the target field.

10. The computer-implemented method of claim 1, wherein directing at least one agricultural operation includes extending one or more contracts during a present growing season of the crop in the target field, in response to defined portions of the target field being of a certain quality.

11. The computer-implemented method of claim 1, wherein directing at least one agricultural operation includes one of:
planting the crop in the target field in a following growing season;
not planting the crop in the target field in the following growing season;
planting a different crop in the target field in the following growing season; or
not planting the different crop in the target field in the following growing season.

12. A non-transitory computer-readable storage medium including executable instructions for providing agricultural operations, which when executed by at least one processor, cause the at least one processor to:
access data associated with a crop in a target field, the data including planting data for the crop and weather data for the target field;
correlate the weather data to each of a plurality of growth stages for the crop in the target field;
prior to a harvest of the crop from the target field, determine a quality of the crop in the target field, based on the correlated weather data and a quality model specific to a type of the crop and independent of a physical examination of the crop in the target field; and
direct at least one agricultural operation consistent with the determined quality of the crop in the target field.

13. The non-transitory computer-readable storage medium of claim 12, wherein the executable instructions, when executed by the at least one processor, further cause the at least one processor to determine the plurality of growth stages of the crops, based on a planting date and a maturity group of the crop in the target field from the planting data; and
wherein each growth stage is associated with a number of days from the planting date.

14. The non-transitory computer-readable storage medium of claim 13, wherein the executable instructions, when executed by the at least one processor to correlate the weather data to each of the plurality of growth stages, cause the at least one processor to aggregate the weather data for each of the plurality of growth stages.

15. The non-transitory computer-readable storage medium of claim 14, wherein the executable instructions, when executed by the at least one processor, further cause the at least one processor to:
train the quality model based on a training set of data, the training set of data including, for a given time period and multiple fields, weather data, planting data and quality data for harvested crops from the multiple fields; and
validate the quality model, prior to determining the quality of the crop in the target field.

16. The non-transitory computer-readable storage medium of claim 15, wherein the executable instructions, when executed by the at least one processor to direct at least one agricultural operation, cause the at least one processor to designate a tag and/or a bag specific to the determined quality of the crop in the target field to be used in bagging the crop at harvest of the crop from the target field.

17. The non-transitory computer-readable storage medium of claim 15, wherein the executable instructions, when executed by the at least one processor to direct at least one agricultural operation, cause the at least one processor to direct an agricultural machine to harvest the crop form the target field at a specific time indicated by the determined quality of the crop in the target field and/or by multiple qualities determined for other fields associated with a grower of the target field.

18. The non-transitory computer-readable storage medium of claim 15, wherein the executable instructions, when executed by the at least one processor to direct at least one agricultural operation, cause the at least one processor to extend one or more contracts during a present growing season of the crop in the target field, in response to defined portions of the target field being of a certain quality.

19. A system for use in providing harvest operation(s) for a crop in a target field, based on a determined quality of the crop in the target field, the system comprising at least one computing device configured to:
access data associated with a crop in a target field, the data including planting data for the crop and weather data for the target field;
correlate the weather data to each of a plurality of growth stages for the crop in the target field;
prior to a harvest of the crop from the target field, determine a quality of the crop in the target field, based on the correlated weather data and a quality model specific to a type of the crop and independent of a physical examination of the crop in the target field; and
direct at least one harvest operation consistent with the determined quality of the crop in the target field.

20. The system of claim 19, further comprising an agricultural machine in communication with the at least one computing device;
wherein the at least one computing device is configured, in order to direct at least one agricultural operation, to direct the agricultural machine to harvest the crop form the target field at a specific time indicated by the determined quality of the crop in the target field and/or by multiple qualities determined for other fields associated with a grower of the target field.
